(19) United States
(12) Patent Application Publication
(10) Pub. No.: US 2015/0120420 A1
(43) Pub. Date: Apr. 30, 2015

(54) Capacity and Demand Matching System

(71) Applicant: Benjamin Richter, Chicago, IL (US)

(72) Inventor: Benjamin Richter, Chicago, IL (US)

(21) Appl. No.: 14/527,724

(22) Filed: Oct. 29, 2014

Related U.S. Application Data
(60) Provisional application No. 61/943,334, filed on Feb. 22, 2014.
(60) Provisional application No. 61/897,075, filed on Oct. 29, 2013.

(51) Int. Cl. G06Q 30/02

(52) U.S. Cl. CPC G06Q 30/0223
USPC 705/14.24

(57) ABSTRACT

A capacity and demand matching system, the system in communication with a server, the system including: a controller; a computer-readable non-transitory memory including instructions, that when executed by the controller, cause the controller to: receive, from a user interface, indications of user demand; communicate the indications of user demand to the server; receive, from the server, an offer for sale; and display, via the user interface, the offer for sale; wherein the indications of user demand include an address, a selection of businesses, and a quantity demanded; the offer for sale identifies a business providing the offer, a discount, and a time period for acceptance; and the business providing the offer is selected from the selection of businesses.

### CROSS-REFERENCE TO RELATED APPLICATIONS

This application claims priority to and the benefit of U.S. Provisional Patent Application No. 61/897,075, filed on Oct. 29, 2013, and U.S. Provisional Patent Application No. 61/943,334 filed on Feb. 22, 2014, the disclosures of each are incorporated herein by reference in their entirety.

### BACKGROUND OF THE INVENTION

The present subject matter relates generally to a capacity and demand matching system to generate orders for goods and services. More specifically, the present invention relates to matching business capacity to fill orders and consumer demand for discounted orders by allowing businesses to indicate their excess capacity and consumers to indicate their desire to receive discounted orders.

For many businesses there are variations in demand over the course of a day, week and/or month. For example, in the foodservice industry, it is common for demand to be high during common mealtime hours, such as a dinnertime rush at 7 pm, and lower during off-peak hours such as 5 pm or 10 pm. Businesses tend to provision resources in order to meet the peak-hours demand, which may lead to excess capacity during off-peak hours. If this excess capacity remains unused as time passes, it is wasted and the restaurant does not receive revenue. Thus, there is a need for systems and methods that generate demand to absorb excess capacity.

Traditional systems of discounting for excess business capacity are costly, difficult to use, and consumers may use them at the least opportune times such as during high demand periods when a business may already be at over capacity. For example, printing and distributing coupons that are available for redemption is costly and requires considerable lead time. Signs advertising short-lived specials may not be seen by clientele, or ideally, the best clientele. Consumers communications, such as email specials, to clients intended to smooth out frequent variations in capacity may annoy consumers to the point that they unsubscribe from the receiving future emails from the business. This is especially true if the emails are sent on a daily basis or more frequently than a daily basis. Once consumers unsubscribe from the email lists, the business loses the ability to market to those unsubscribed individuals. What is needed are quick, efficient, and annoyance free ways of generating and responding to consumers demand using available capacity resources during low capacity periods.

Traditional incentive systems fail to take advantage of consumers' willingness to be flexible to get the best deal. For many consumers, there is a willingness to tailor his or her demands to get a better deal. For example, many consumers who are interested in ordering food may be flexible about what time they receive or pickup their food, or from which business they purchase the food, in return for discounts or incentives. Previous incentive systems, such as coupons or vouchers, do not best address the issue of solving a business' underused capacity. An example of this is an established restaurant that has obvious periods of demand outweighing capacity, thereby causing that restaurant to lose revenue when consumers use a coupon or voucher at these peak periods and to lose even more revenue when consumers who do not have a coupon or voucher and are willing to pay full price leave because of the long wait time. Therefore, a system and method is needed to move the dining time of consumers who require or prefer discounts to excess capacity time periods while retaining full paying consumers at lower capacity time periods.

Also, incentive systems for online food ordering companies generally only provide lists, which may be searchable, of pre-existing, static specials from currently available restaurants. Thus, there is a need for dynamic systems and methods to discover consumers demand that are superior to choosing from pre-existing lists, coupons and vouchers.

Accordingly, there is a need for dynamic capacity and demand matching systems and methods that consume wasteful excess business capacity and that tap into unexploited consumers demand, as described herein.

### BRIEF SUMMARY OF THE INVENTION

To meet the needs described above and others, the present disclosure provides a capacity and demand matching system. The capacity and demand matching system matches consumers interested in receiving offers, including deals or specials, with businesses that are willing to provide incentives to encourage orders to maximize the use of their productive capacity.

The examples embodiments disclosed herein illustrate an embodiment of the invention for use by restaurants and their consumers. It will be understood by those of ordinary skill in the art that the subject matter disclosed herein may be used in a variety of industries and that the disclosure should not be read to be limited to uses in the foodservice industry. However, many of the teachings provided herein are believed to be most advantageous for use in systems in which a retailer (business-to-business or business-to-consumer) wants to generate additional demand for excess off-peak capacity and the customer (business or consumer) is making a purchasing decision from amongst a plurality of options. Although recognized as being useful in business-to-business contexts, the description throughout will rely mainly on business to consumer applications in order to retain clarity. In all instances, it is understood that the customer may be any type of customer.

The capacity and demand matching system may be embodied in a matching server that communicates with the business devices of affiliated businesses and consumer devices of affiliated consumer over a communications network, such as the Internet, to carry out the functionality described herein. Additionally, the capacity and demand matching system may be embodied in a consumer application run on the consumer device, in a business application run on a business device, and in combinations of the matching server, the consumer device, and the business device.

In a simple example embodiment, a consumer may use the consumer application to turn herself ‘on’ as available to receive offers from various businesses. Turning oneself ‘on’ in the capacity and demand matching system may be as simple as the consumer opening an ‘on’ screen and toggling on the ‘on’ button. The consumer device may then communicate with the matching server that the consumer has turned herself ‘on’ and in response, the matching server may begin generating offers for delivery to the consumer. For example, the matching server may match the consumer with a business that has turned itself ‘on’ and then generate an offer on behalf of the business. Offers may be generated using automated reasoning that considers the consumer's previous behavior, previous business behavior, current capacity indicated by businesses, etc., as described herein.

The matching server may then transmit an offer to the consumer device for viewing by the consumer. The offer may include an incentive to encourage the consumer to make an order. Incentives may include a discount off the regular prices, free delivery, free extras, or any other form of encouragement to get the consumer to make an order. An offer may specify particular goods and services covered by the offer or may apply to all goods and services sold by the business. The consumer may choose between accepting the offer and declining the offer by choosing between an accept button and a decline button. If the consumer accepts the offer, the consumer may be directed to an order screen to finalize an order. The order may then be sent to the business for fulfillment.

As suggested, offers may be made from businesses registered with the capacity and demand matching system to consumers registered with the system. Through regular interactions with businesses and consumers, the capacity and demand hatching system may generate business profiles and consumer profiles that may be used to predict, via automated reasoning, matches between consumers and business that are likely to result in an orders when the consumer is presented with an offer from that business. The capacity and demand matching system may accordingly generate offers based solely on the businesses' indication of interest in receiving orders when it turns itself ‘on,’ and the consumer's indication of interest in receiving offers when she turns herself ‘on’ (as may be stored in an on status in the consumer profiles and business profiles). Accordingly, it is not necessary that the business provide exact information about its interest in receiving orders, nor is it necessary that the consumer provide exact information about her interest in receiving offers.

Nevertheless, the capacity and demand matching system may include functionality to receive capacity information and demand information from businesses and consumers in order to build consumer profiles and business profiles and to respond to the current desires of the business and consumers. This functionality may allow a business to further specify its desire to receive orders, and allow a consumer to further specify her desire to receive offers.

In a simple example embodiment, a business may use the business application to provide capacity information in the form of a request for orders for pickup. An employee of the business may use the pickup request screen of the business application to request orders. The pickup request screen may permit the employee to input a number of requested orders, a desired response time, and a maximum discount. The number of requested orders may indicate the number of separate orders that a business would like to receive from the matching server. The response time indicates the length of the period during which the business would like to receive the orders. And the maximum discount is the maximum amount of discount that the business is willing to provide to obtain the desired orders. For example, a business may discount up to twenty percent to receive up to four orders within thirty minutes. Upon acceptance, the request for orders for pickup may be sent to the matching server. The matching server may then match the business with consumers and begin sending offers to the consumers to drive orders.

Similarly, to request orders for delivery, the business may use a delivery request screen. The business may input a number of delivery drivers. The matching server may attempt to generate orders that are clustered in a number of clusters that matches the number of delivery drivers to optimize the use of the drivers. Like the pickup request screen, the delivery request screen, may permit the business to input a number of requested orders, a response time, and a maximum discount.

In a more complex embodiment, a business may provide even greater capacity information to the matching server, once again in the form of a request for orders. A capacity entry screen of the business application may include an ability to specify they order type desired, such as, pick-up, delivery, both, etc. In other embodiments, order type may also include dine-in. Additionally, the capacity entry screen may include an input to enter a time slot during which the orders are desired. For a time slot, the employee may enter an order quantity and a time slot length around the time slot that the orders are desired. The order quantity in the example is expressed in terms of a number of food items the business desires to sell. The order quantity is analogous to the number of requested orders and either one or both may be used in an embodiment to describe available capacity. The capacity entry screen may permit the employee to specify multiple capacity slots with varying time slots, order quantities, order types, etc., to enable coverage of various periods of excess capacity. For example, an employee may indicate the capacity to make up to 8 pizzas in the 2:30, 3:30 and 4:30 capacity slots. During normal operation, the employee may enter the available capacity into the business application as needed, and modify or cancel the capacity information as needed.

The business may also input various permissible incentives that may be included in an offer to encourage the consumer to accept the offer. Incentives may include free delivery, a discount or percentage off the total, or free products and services. It is contemplated that incentives may include any material or non-material reward that would be expected to induce a consumer to accept an offer.

The matching server may use the incentives to continuously generate offers until a sufficient number of orders have been received to fill the available capacity of a business. For example, one-by-one, the matching server may send out offers to all consumers that have indicated an interest in the business. If the response to offers is low, the matching server may periodically increase the value of the incentives included in the offers to improve the conversion rate. It is appreciated that there are many possible strategies for generating offers and targeting offers to various consumers, and, accordingly, the strategies disclosed herein will not be understood by those of skill in the art as limiting the system to any particular choice of offer generation and matching strategies except as provided in the appended claims.

Next, the business may input existing deliveries into the other deliveries screen. This permits the matching server to take existing deliveries into account when weighing which consumers should receive offers. In the other deliveries screen, an employee of the business may be prompted with an input to enter a number of existing deliveries. According to the number of existing deliveries entered, the other deliveries screen may be updated to include a sufficient number of inputs to receive the delivery addresses of all existing deliveries.

Finally, having inputted the relevant capacity information, the business may review the capacity information in a confirmation screen. The confirmation screen may remind the employee of the number of orders requested for each order type (pick-up, delivery, etc.), the response time desired (or in some embodiments, the capacity for various time slots and the time slot length), the number of requested orders (or in some embodiments, the order quantity), and the maximum discount.

The capacity and demand matching system is configured to independently generate offers and provide them to consumers without needing input from the business. Nevertheless, it is contemplated that some businesses may desire to retain a level of control over the offers made on their behalf. Accordingly, in some embodiments, before an offer is made to a consumer, the business may review the offer and accept or reject it. When a potential offer is generated, it may be sent to the business for review. The potential offer may be displayed in a popup menu along with details of the offer including the incentive. The employee may choose a view button to view details of the offer and the consumer it is being offered to, such as the consumer's current location, the consumer's quantity of goods and services desired, the consumer's order type (pick-up, delivery, dine-in), etc. If the offer is acceptable, the employee may click the accept button to have the offer made to the consumer.

As previously described, a consumer may begin to receive offers by simply turning herself ‘on’ for offers. It is contemplated that a consumer need not even turn herself ‘on’ in order to receive offers. For example, offers may be displayed automatically upon opening of the consumer application. This way, the act of affirmatively turning oneself ‘on’ may provide an additional signal that the consumer is interested in receiving offers, while the mere act of opening the consumer application may cause the consumer application to begin displaying offers.

To permit the capacity and demand matching system to better tailor offers to consumers, the consumer application may include functionality to better determine consumer demand by developing a consumer profile of the consumer. For example, the consumer application may include menus to receive inputs of further information about the consumer's current preferences and interests regarding offers.

The consumer may indicate various details of offers the consumer may be interested in. First, in the order method screen, the consumer may choose to use traditional delivery options to immediate order food, or may choose the ‘on’ option button to turn herself ‘on’ for offers. The order method screen may include available discounts information that may be available to the consumer.

If the consumer chooses to turn herself ‘on’, the consumer may be taken to an order type screen. In the order type screen, the consumer may select from the order types to indicate interest in offers for pick-up, delivery, or both. In other embodiments, dine-in may be a further option.

Then, the consumer may proceed to a location screen that prompts the consumer to indicate her current location. The consumer's current location may be used to determine nearby businesses that the consumer may be interested in receiving pickup from, or to determine where she will receive deliveries. The consumer may be presented with a locations input that may be radio selection buttons to permit the consumer to select from a list of pre-populated locations. Additionally, in some embodiments, the consumer may be permitted to use GPS to determine her current location (with or without active input by the consumer). In further embodiments, the consumer may be permitted to type in an address as the current location.

Next, the consumer may be permitted to input a selection of businesses into a restaurants screen that indicate the restaurants or the categories of restaurants from which the consumer would be interested in receiving offers. In an example, multiple category menus are displayed as expandable accordion menus each containing selectable businesses. In some embodiments, the consumer may select the category menus to automatically select all the businesses contained within.

Further, the consumer may input of a quantity of goods and services desired in the quantity screen. In an embodiment, the quantities of food may be inputted as a number of people that an order is intended to feed. The consumer may input a number of adults, a number of teenagers, and a number of children. It is contemplated that in other embodiments, the quantity of goods and services desired may be inputted in other manners, such as, a selection of particular goods and services, a price range of goods and services, or a selection of incentives desired.

Next, when the consumer has indicated an interest in pickup orders, the consumer may be prompted to indicate the distance she would be willing to travel to make the pickup. For example, in a travel distance screen, the consumer may be prompted to enter a travel distance. The matching server may then restrict the offers it provides to the consumer to those businesses that are within the travel distance provided by the consumer.

In some embodiments, an overview screen may be displayed to permit the consumer to review open offers, accepted offers, and declined offers. For open offers, the remaining time of the time limit may be displayed to permit the consumer to review the available offers.

A capacity and demand matching method is provided to provide the functionality of the capacity and demand matching system. The capacity and demand matching method may begin when the employee of a business enters capacity information into the business device. For example, the business device receives an input of capacity (such as a number of requested orders, a response time, and a maximum discount, or a order type, a time slot, an order quantity, and a time slot length); and the business device transmits the capacity to matching server. Next, the business device receives an input of existing orders, and, transmits the existing orders (including the existing delivery addresses) to matching server that receives the existing orders. Then, the business device receives an input of discounts and incentives, and, transmits the discounts and incentives to matching server. Finally, at any time and regardless of capacity information provided, the business device may receive an input of a request for orders, and at step, transmit the request for orders to the matching server. Upon receiving the capacity information, it may be stored in the business profile. And, upon receiving a request for orders, the on status of the business may be updated.

Also, as reflected in the capacity and demand matching method, the consumer may also enter demand information into the consumer device. First, the consumer device receives an input of a selection of businesses to receive offers from, and the consumer device transmits the selection of businesses to the matching server. Next, at step, the consumer device receives an input of a quantity of goods and services desired, the consumer device transmits the quantity of goods and services desired to the matching server. Then, the consumer device receives a selection of a current location, and the consumer device transmits the current location to the matching server. Further, the consumer device receives a selection of pickup, delivery, or dine-in (the order type), and the consumer device transmits the order type to the matching server. Upon receiving the demand information, the matching server may store it in the consumer profile.

The matching server may continuously make offers to consumers in order to generate orders for businesses. As reflected in the capacity and demand matching method, the matching server matches a consumer with a business to generate an offer, the matching server communicates the offer to the matched consumer. The offer may include a incentive from the selected (matched) business and a time limit.

Upon receiving an offer, the consumer device displays the offer to the consumer for the duration of the time limit. The consumer may view the offer and accept or decline it. The consumer device receives acceptance of the offer within the time limit or receives a rejection. When the offer is accepted within the time limit, the consumer device transmits the acceptance of the offer to the matching server that receives acceptance. The acceptance of the offer may be, or may include, an order. If the offer is not accepted, the matching server contacts the business to generate further offers. And, when, after receiving acceptance of an offer, the business still has available capacity, the matching server may generate further offers. For any orders received from the consumer device, the matching server transmits the order to the business device, and the order is, in turn, received by the business device.

In addition to continuously generating offers, the matching server may continuously check for imbalances between the capacity available by businesses and the demand from consumers. Accordingly, if the matching server observes ‘on’ consumers (as may be reflected in the on status and demand information) that are not receiving offers, the matching server may request capacity information from businesses with a current high predicted likelihood of matching with the ‘on’ consumers.' The predicted likelihood of matching with ‘on’ consumers may be calculated from the consumer profiles, including the consumers' selection of businesses, consumers' feedback history, transaction history, etc. Then, when contacted by the matching server, the business device may receive input of capacity information.

The matching server may include a controller for executing matching server instructions stored in a memory. A network interface in communication with the controller permits the controller to communicate with the consumer device and the business device over a network, such as the Internet. The matching server may include a database that is in communication with the controller and that stores consumer profiles and business profiles for use in carrying out the functionality of the capacity and demand matching system.

The matching server may use consumer metrics and business metrics to match consumers and businesses when generating offers. The consumer metrics and business metrics may be derived from the information stored in the consumer profiles and the business profiles. The matching server may be in communication with a consumer device and a business device. The consumer device and the business device may both include a controller; a memory, a network interface, and a user interface. The memory of the consumer device may store the consumer application; likewise, the memory of the business device may store the business application.

For each consumer that has selected a business, the matching server may calculate a likelihood of desirability of that consumer to the business. The likelihood of desirability may be calculated based on the consumer metrics and any other information in the consumer profile or the business profile. In an embodiment, the matching server may select consumers with a high likelihood of desirability and send those consumers offers from the business.

Likewise, for each business that has been selected by a consumer, the matching server may calculate a likelihood of acceptance of an offer from the business by the consumer. The likelihood of acceptance may be calculated based on the business metrics, and any other information in the business profile or the consumer profiles. In an embodiment, the matching server may select businesses with a high likelihood of acceptance for a consumer and send the consumer offers from those businesses.

As noted, the consumer metrics and business metrics may be derived from the information stored in the consumer profiles and the business profiles. Availability metrics indicate the availability of the business to receive additional orders. For example, a business may indicate that it is currently ‘off’ for pickup and delivery orders. A business may turn itself ‘off’ during times of the day or week that it is traditionally busy with other orders, for example, for many restaurants the Friday night period from 6:30 pm until 8:30 pm is usually too busy to need additional demand. Alternatively, a business may be ‘off’ because they are closed. When the business is ‘off,’ consumers may still be permitted to make traditional orders using the consumer application, however, the system may refrain from making offers on behalf of the business. In some embodiments, a business may schedule periods of availability or non-availability to receive orders. Alternatively, a business that has scheduled itself to be ‘off’ may find they are slower than usual (e.g., has underused capacity) and may turn themselves ‘on’ and available for orders, as needed throughout the business day.

In the consumer context, availability metrics indicate the availability of the consumer to make an order. For example, availability metrics may include whether the consumer is currently turned ‘on’ to indicate a willingness to receive offers. Additionally, availability metrics may include the consumer's distance from the business.

Desirability metrics indicate the general desirability of a particular business to consumers, and vice versa. The desirability of a business may be derived from the interests expressed by consumers when they turn themselves ‘on.’ For example, consumers may indicate an interest in receiving offers from particular businesses. Desirability metrics may also include the number of consumers nearby the business and may take into account the distance each consumer has indicated he or she would be willing to travel. A further example of a desirability metrics is the number of consumers who have indicated an interest in a category a business is classified in.

Transaction history metrics may consider the past history of businesses and consumer with the capacity and demand matching system, such as previous orders a business or consumer has completed. For example, transaction history metrics may take into account, for example, the times of day, the days of week, the days of the month, etc., that businesses have had available capacity. Additionally, the transaction history metrics may take into account the responsiveness of business after being contacted by the matching server to obtain capacity information.

In the consumer profile, transaction history metrics may consider the past history of consumers with the capacity and demand matching system. For example, transaction history metrics may take into account the previous orders a consumer has completed. Transaction history metrics may take into account, for example, the times of day, the days of week, the days of the month, etc., that consumers have completed orders. Additionally, the transaction history metrics may take into account the responsiveness of a consumer after being contacted with an offer.

Transaction value metrics may consider the value of past transactions completed by businesses via the capacity and demand matching system. In the business profile, transaction value metrics may include the average spend per order purchased from a business by a consumer over previous periods. Transactions value metrics may further include the average dollar amounts of orders for a business. Further, the transaction value metrics may take into account the total of all transaction values over particular periods comparable to the period for which offers are desired. For example, if offers are desired for 2 p.m.-4 p.m. on a weekday, the system may look at previous weekdays at the same time to gauge likely transaction values.

In the consumer context, transaction value metrics may consider the value of past transactions completed by the consumers via the capacity and demand matching system. Transaction value metrics may include the average dollar amounts of orders purchased by a consumers over previous periods. Alternatively, transaction value metrics may be weighted in comparison to other consumers. Additionally, the transaction value metrics may take into account the transaction values over particular periods comparable to the period for which extra demand is desired by businesses. Transaction value metrics may also take into account whether the consumer spends more or less on average during a particular time of the day compared to other times of the day, on a particular day compared to other days, on a particular time of day compared to other times of the day, and in comparison to other consumers. Further, transaction value metrics may take into account whether a particular consumer has made large and/or small outlier pick-up order transaction values that may be removed to get a better average purchase value.

Feedback metrics include metrics that are derived from feedback history of businesses and consumers. Consumers may be permitted to provide ratings, reviews, rankings, comments, complaints, and other feedback about orders placed through the system. Accordingly, Feedback metrics may include metrics that are derived from consumers feedback about a business. For example, the ratings of a business may be aggregated into a consumer feedback metric for the business. Feedback metrics may additionally include information about any steps a business took to respond to negative reviews, complaints, including whether a refund or credit was given.

Feedback metrics may include the complaint history of consumers. For example, consumers with a history of excessive complaints or refund requests may be weighted lower. If a consumer has given complaints, the feedback metrics for a business may include the ratio of orders with complaints to orders without complaints, and/or the ratio of orders with complaints to total orders made by the consumer. These ratios can be expressed in total number of orders and/or in dollar amounts. Additionally, the feedback metrics may be adjusted based on the evolution of the ratios over various periods of times, and may be adjusted based on a comparison with other consumer. Similarly, feedback metrics may be adjusted based on whether a consumer requested and/or received refunds or credits to settle disputes. Further, in some embodiments, businesses may be permitted to rate consumers. The business ratings may be aggregated into an average rating from restaurants feedback metric.

As noted, consumers and businesses may be matched using a calculated likelihood of desirability of consumer for a business, and a calculated likelihood of acceptance when a consumer receives an offer from a business. The matching server may generate one or more candidate matches of consumers and businesses. For example, the matching server may generate candidate matches from those consumers with a high likelihood of desirability for one or more businesses, and/or may generate matches from those businesses with a high likelihood of acceptance of an offer by one or more consumers. Alternatively, the matching server may generate a candidate match for all pairs of consumers and businesses that are have on status that is ‘on’ for one of pickup, delivery, dine-in, etc. For each candidate match, the matching server may combine the likelihood acceptance with the likelihood of desirability to generate a joint likelihood of an acceptable match. The matching server may then make offers to each consumer of one or more candidate matches having the highest joint likelihood of an acceptable match.

An offer will identify the business that the consumer has been matched with. To encourage the consumer to accept the offer and place an order, an offer may include the maximum discount provided by the business as an incentive. Alternatively, the incentive may be a discount less than the maximum discount, for example, the incentive may be equal to the average discount of all offers accepted by the consumer. Additionally, the offer may include time limit equal to the response time indicated by the business, or equal to the time slot length.

As noted, the capacity and demand matching system may monitor the demand information and capacity information of the consumer profiles and business profiles. When there is an excess of demand, the matching server may contact businesses and encourage them to turn themselves ‘on.’ The matching server may reach out to the specific businesses that have the highest likelihood to provide an offer that will be accepted by consumers when queried. The likelihood to provide an offer may be calculated based on the consumer metrics and business metrics. Examples of consumer metric and business metrics that may indicate a high probability of providing an offer that will have a high likelihood of acceptance by the consumer when queried includes the availability metrics, feedback metrics, transaction history metrics, transaction value metrics, etc. One skilled in the art will appreciate that these metrics are example metrics and that other metrics may be used, and the listed metrics may be omitted or adapted in various ways.

It is contemplated that the capacity and demand matching system may not always have sufficient information about the consumer or the business to generate offers for each consumer or business. For example, a consumer and a business “new” to the system may simply turn themselves “on” without indicating any present capacity or demand. In these circumstances, in some embodiments, the capacity and demand matching system may generate offers based on other businesses and consumers in the system, such as “most popular” offers, offers based on business or consumers demographic preferences, random offers, etc. By generating offers for consumers with undeveloped consumer profiles, the capacity and demand matching system ensures that new or infrequent consumer and a business will still receive offers and orders.

Additionally, it is contemplated there may occur times when a consumer turns herself ‘on’ where she doesn't receive sufficient offers to keep her interested in the system. This may occur for a variety of reasons, such as, low capacity in the system resulting in small discounts. If this were to occur frequently, it may cause the capacity and demand matching system to lose consumer users. Accordingly, the system may monitor for signs that a consumer is losing interest. For example, the system may determine that the amount of time a consumer is ‘on’ is decreasing over time (such as forty minutes the first five times, and then twenty minutes the next three times). Alternatively, the system may determine that the time between ‘on’ sessions is increasing. To prevent this situation from causing consumers to leave the system, the system may ‘override’ the normal matching patterns to generate offer geared to retain the consumer. In some embodiments, the owners of the capacity and demand matching system rather than the business providing the offer may pay for the incentives provided in an offer created by an override.

In an embodiment, an override may be triggered when the number of times an offer was sent divided by the number of times consumers turned on goes below a threshold. In another embodiment, an override may be triggered when the number of times an offer was accepted divided by the number of times the consumers turned on goes below a threshold. In an additional embodiment, an override may be triggered when the number of times offer was selected by a consumer divided by the number of times an offer was sent to the consumer goes below a threshold. From the example provided, many other alternative formulas for determining when to override the existing matching will be apparent to those of ordinary skill in the art.

In an embodiment, a capacity and demand matching system includes: a controller; and a computer-readable non-transitory memory including instructions, that when executed by the controller, cause the controller to: receive, from a user interface, indications of user demand; communicate the indications of user demand to the server; receive, from the server, an offer for sale; and display, via the user interface, the offer for sale; wherein the indications of user demand include an address, a selection of businesses, and a quantity demanded; the offer for sale identifies a business providing the offer, a discount, and a time period for acceptance; and the business providing the offer is selected from the selection of businesses.

In an embodiment, the selection of businesses is received as one or more categories of businesses. Also, in some embodiments, the selection of businesses is received as an identification of two or more businesses. Additionally, in some embodiments, the quantity demanded is received as an identification of a number of persons. Moreover, in some embodiments, the quantity demanded is received is indicated by a selection of food items. Further, in some embodiments, the indications of user demand further include a minimum discount. Even further, in some embodiments, the indication of user demand further includes a price range.

In an embodiment, a capacity and demand matching system includes: a controller; and a computer-readable non-transitory memory including instructions, that when executed by the controller, cause the controller to: receive, from a user via a user interface, indications of user capacity; communicate the indications of user capacity to the server; receive, from the server, an accepted sale; and displaying, via the user interface, the accepted sale; wherein the indications of user capacity include a desired number of sales, an incentive, and a time period; and the accepted sale identifies a consumer, an address, and an order of goods, services, or goods and services provided by the user.

In an embodiment, a capacity and demand matching system includes: a controller; and a computer-readable non-transitory memory including instructions, that when executed by the controller, cause the controller to: receive, from a consumer device of the consumer devices, indications of user demand; receive, from a supplier device of the supplier devices, indications of supplier demand; and communicate, to the consumer device, an offer for sale; wherein the indications of user demand include an address, a selection of businesses, and a quantity demanded; the indications of user capacity include a desired number of sales, an incentive, and a time period.

An object of the invention is to provide a solution to underused capacity (e.g., lower demand) during off-peak or low-peak hours.

Another object of the invention is to provide new mechanisms for consumers to receive and discover deals on goods and services.

An advantage of the invention is that it provides a mechanism to receive offers without searching or filtering by the consumers to remove offers not desired by a consumers.

Another advantage of the invention is that it provides an easy to use tool to generate additional offers to fill available capacity.

A further advantage of the invention is that it provides a tool for consumers to receive offers of interest with minimal investment of time and searching.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic diagram illustrating the ecosystem of an example capacity and demand matching system.

FIG. 2a is an ‘on’ screen of the business application of the capacity and demand matching system of FIG. 1 that may be used by a consumer to turn herself on to receive offers.

FIG. 2b is an offer screen of the business application of the system of FIG. 1 that may be used by a consumer to accept or decline an offer.

FIG. 2c is a pickup request screen of the system of the business application of FIG. 1 that may be used by an employee of a business to request that offers be made to consumers to generate orders.

FIG. 3a is a capacity entry screen of the business application of the system of FIG. 1 that may be used by an employee to enter the excess capacity of a business.

FIG. 3b is an input screen of the business application of the system of FIG. 1 to receive incentives that may be included in an offer to induce a consumer to make an order.

FIG. 3c is a other deliveries screen of the business application of the system of FIG. 1 to receive one or more addresses of existing deliveries to permit the system to make offers to nearby consumers.

FIG. 3d is a confirmation screen of the business application of the system of FIG. 1 to permit an employee to review capacity information before submission to a matching server of the system.

FIG. 3e is a delivery request screen of the business application of the system of FIG. 1 to permit an employee to request additional delivery orders.

FIG. 3f is a screen of the business application of the system of FIG. 1 including potential offer displayed for review by an employee.

FIG. 4a is an order method screen of the consumer application of the system of FIG. 1 that may be used by a consumer to select between traditional ordering and receiving offers from selected businesses.

FIG. 4b is an order type screen of the consumer application of the system of FIG. 1 that may be used by a consumer to select between delivery, pickup, or both.

FIG. 4c is a location screen of the consumer application of the system of FIG. 1 that may be used by a consumer to set her current location.

FIG. 4d is a restaurants screen of the consumer application of the system of FIG. 1 that may be used by a consumer to make a selection of businesses that she would prefer to receive offers from.

FIG. 4e is a quantity screen of the consumer application of the system of FIG. 1 that may be used by a consumer to input the quantity of goods and services desired.

FIG. 4f is a travel distance screen 480 of the consumer application of the system of FIG. 1 that may be used by the consumer to indicate the distance she would be willing to travel to pickup an order.

FIG. 4g is overview screen of the consumer application of the system of FIG. 1 that may be viewed by the consumer to see the currently open offers, previously accepted offers, and previously declined offers.

FIGS. 5a, 5b, and 5c illustrate an example capacity and demand matching method that may be carried out by the capacity and demand matching system to accomplish the functionality described herein.

FIG. 6a is a schematic diagram of a matching server of the system of FIG. 1.

FIG. 6b is a schematic diagram of a consumer device of the system of FIG. 1.

FIG. 6c is a schematic diagram of a business device of the system of FIG. 1.

FIG. 7a is a table illustrating a portion of sample consumer profiles for consumers that have selected to receive offers from an example “Restaurant A.”

FIG. 7b is a table illustrating a portion of sample business profiles for businesses that a “Consumer 16” has indicated that she would like to receive offers from.

FIG. 7c is a table illustrating ranked matches of pairs of businesses and consumers.

### DETAILED DESCRIPTION OF THE INVENTION

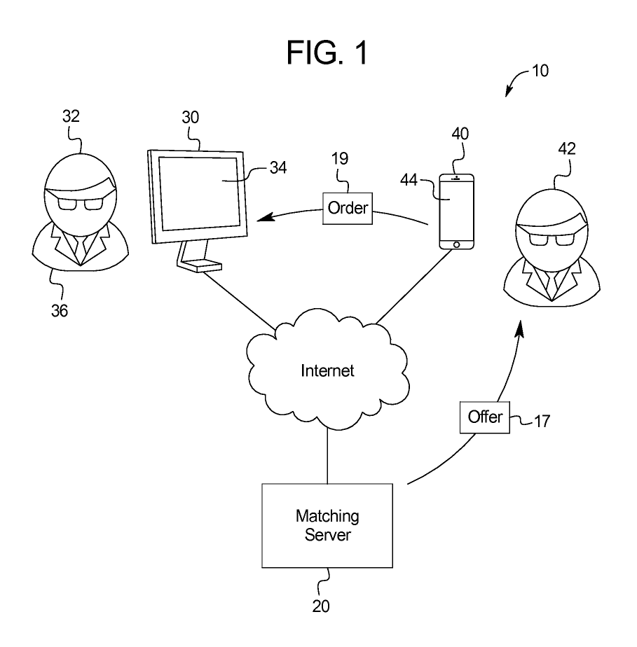

FIG. 1 illustrates the ecosystem of an example of the capacity and demand matching system 15. The capacity and demand matching system 15 matches consumers 42 interested in receiving offers 17 including deals or specials with businesses 32 who are willing to provide incentives to encourage orders 19 to maximize the use of their productive capacity. To provide a motivating example, the Figures of the present application are directed to pizzeria that desires to receive pizza orders for pickup during off-peak hours, and to a consumer 42 interested in receiving offers 17 for discounted pizza. It will be understood by those of ordinary skill in the art that this motivating example is just one of many possible uses of the system and that this example does not limit the scope of the present subject matter.

The capacity and demand matching system 15 may be embodied in a matching server 20 that communicates with the business devices 30 of affiliated businesses 32 and consumer devices 40 of affiliated consumer 42 over a communications network, such as the Internet, to carry out the functionality described herein. Additionally, the capacity and demand matching system 15 may be embodied in a consumer application 44 run on the consumer device 40, in a business application 34 run on a business device 30, and in combinations of the matching server 20, the consumer device 40, and the business device 30.

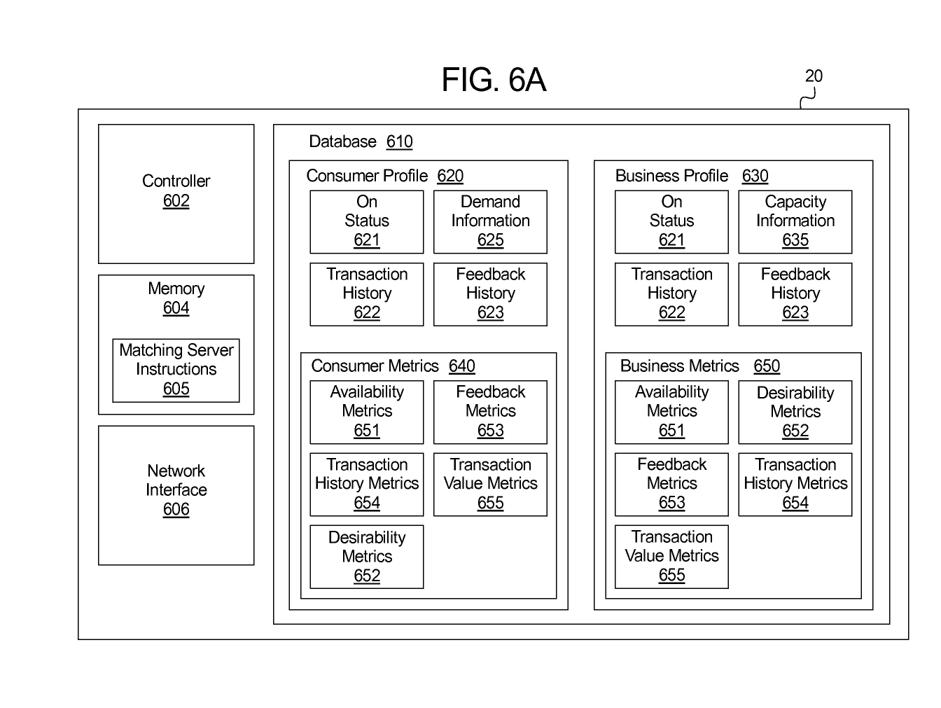

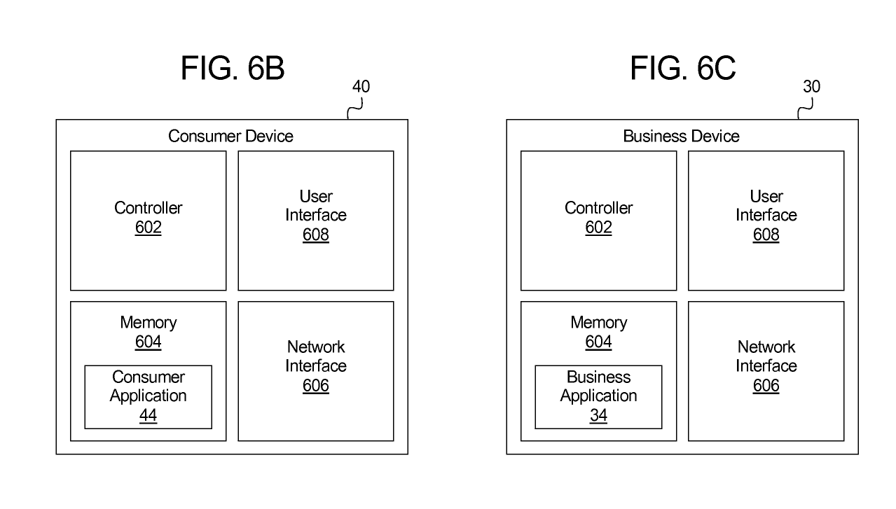

Business devices 30 may include mobile devices, tablets, point-of-sale systems, customer relationship management systems, business software portals, etc. Likewise, consumer devices 40 may include mobile devices, tablets, personal computers, etc. The business devices 30 and consumer devices 40 may be conventional in nature and the consumer application 44 and business application 34 may include stored computer instructions for execution by controllers 602 (FIGS. 6b and 6c) to carry out the functionality described herein. Although the embodiments herein are drawn to business applications 34 and consumer applications 44 that are provided as native applications, it is contemplated that businesses 32 and consumers 42 may access the capacity and demand matching system 15 using a web interface.

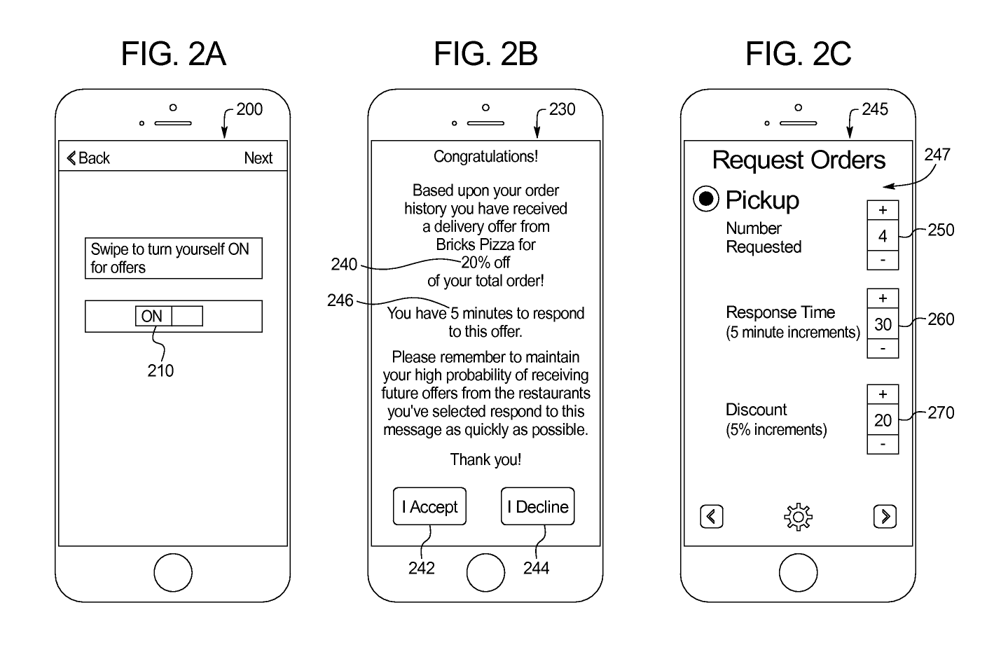

In a simple example embodiment, a consumer 42 may use the consumer application 44 to turn herself ‘on’ as available to receive offers from various businesses 32. As shown in FIG. 2a, turning oneself ‘on’ in the capacity and demand matching system 15 may be as simple as the consumer 42 opening an ‘on’ screen 200 and toggling on the ‘on’ button 210. The consumer device 40 may then communicate with the matching server 20 that the consumer 42 has turned herself ‘on’ and in response, the matching server 20 may begin generating offers 17 for delivery to the consumer 42. For example, the matching server 20 may match the consumer 42 with a business 32 that has turned itself ‘on’ in the manner of FIG. 2a and then generate an offer 17 on behalf of the business 32. Offers 17 may be generated using automated reasoning that considers the consumer's previous behavior, previous business behavior, current capacity indicated by businesses, etc., as described herein.

The matching server 20 may then transmit an offer 17 to the consumer device 40 for viewing by the consumer 42. FIG. 2b illustrates an example offer 17 received by the consumer 42. As shown, the offer 17 may include an incentive 240 to encourage the consumer 42 to make an order 19. Incentives 240 may include a discount off the regular prices, free delivery, free extras, or any other form of encouragement to get the consumer 42 to make an order 19. An offer 17 may specify particular goods and services covered by the offer 17 or may apply to all goods and services sold by the business. The consumer 42 may choose between accepting the offer 17 and declining the offer 17 by choosing between an accept button 242 and a decline button 244. If the consumer 42 accepts the offer 17, the consumer 42 may be directed to an order screen to finalize an order 19. The order may then be sent to the business 32 for fulfillment.

As suggested, offers may be made from businesses 32 registered with the capacity and demand matching system 15 to consumers 42 registered with the system. Through regular interactions with businesses 32 and consumers 42, the capacity and demand matching system 15 may generate business profiles 630 (FIG. 6a) and consumer profiles 620 (FIG. 6a) that may be used to predict, via automated reasoning, matches between consumers 42 and business 32 that are likely to result in an orders 19 when the consumer 42 is presented with an offer 17 from that business. The capacity and demand matching system 15 may accordingly generate offers 17 based solely on the businesses' indication of interest in receiving orders when it turns itself ‘on,’ and the consumer's indication of interest in receiving offers 17 when she turns herself ‘on’ (as may be stored in an on status 621 in the consumer profiles 620 and business profiles 630). Accordingly, it is not necessary that the business 32 provide exact information about its interest in receiving orders 19, nor is it necessary that the consumer 42 provide exact information about her interest in receiving offers 17.

Nevertheless, the capacity and demand matching system 15 may include functionality to receive capacity information 635 (FIG. 6a) and demand information 625 (FIG. 6a) from businesses 32 and consumers 42 in order to build consumer profiles 620 and business profiles 630 and to respond to the current desires of the business 32 and consumers 42. This functionality may allow a business 32 to further specify its desire to receive orders 19, and allow a consumer 42 to further specify her desire to receive offers 17.

In a simple example embodiment, shown in FIG. 2c, a business 32 may use the business application 34 to provide capacity information 625 in the form of a request for orders 247 for pickup. As shown, an employee 36 of the business 32 may use the pickup request screen 245 of the business application 34 to request orders 19. The pickup request screen 245 may permit the employee 36 to input a number of requested orders 250, a desired response time 260, and a maximum discount 270. The number of requested orders 250 may indicate the number of separate orders 19 that a business 32 would like to receive from the matching server 20. The response time 260 indicates the length of the period during which the business 32 would like to receive the orders 19. And the maximum discount 270 is the maximum amount of discount that the business 32 is willing to provide to obtain the desired orders 19. In the shown example, the example business 32 is willing to discount up to twenty percent to receive up to four orders within thirty minutes. Upon acceptance, the request for orders 247 for pickup may be sent to the matching server 20. The matching server 20 may then match the business 32 with consumers 42 and begin sending offers 17 to the consumers 42 to drive orders 19.

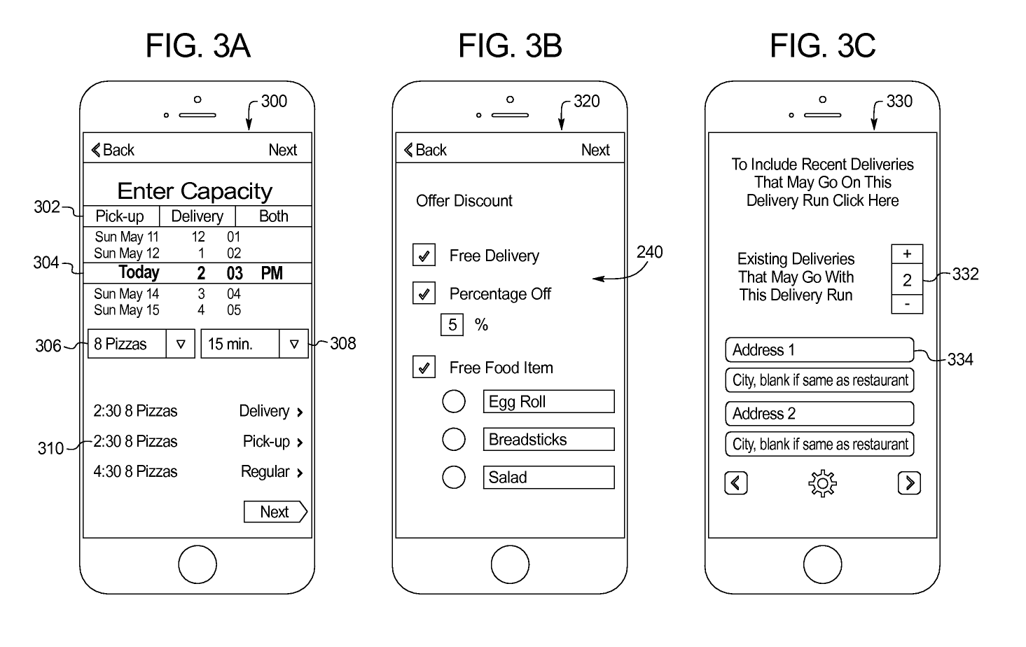

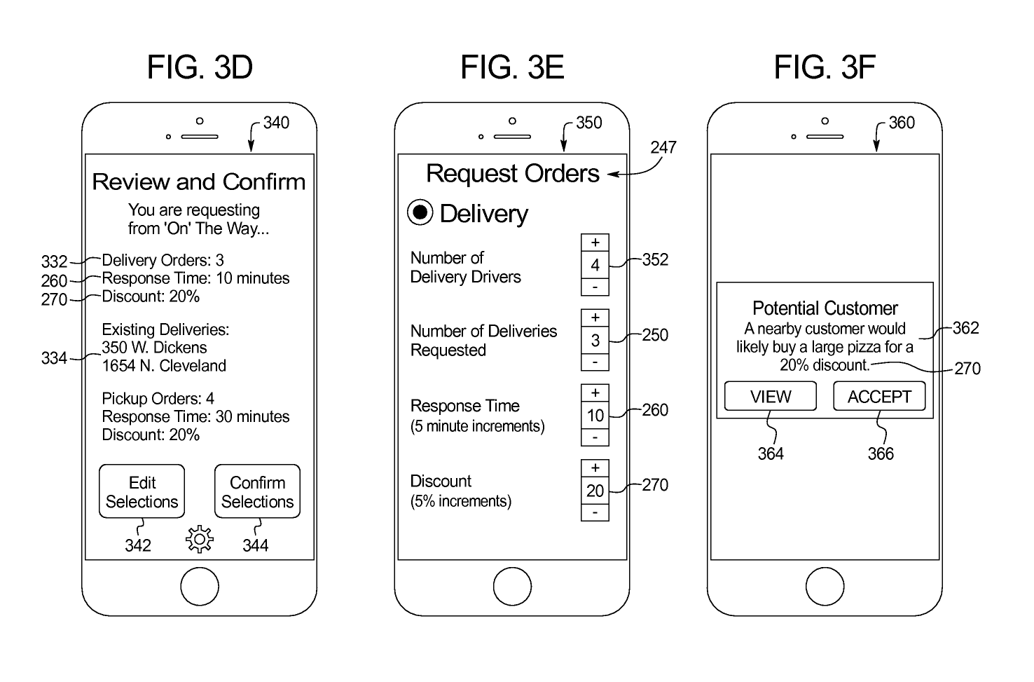

Similarly, to request orders 19 for delivery, the business 32 may use a delivery request screen 350, as shown in FIG. 3e. The business 32 may input a number of delivery drivers 352. The matching server 20 may attempt to generate orders 19 that are clustered in a number of clusters that matches the number of delivery drivers 352 to optimize the use of the drivers. Like the pickup request screen 245, the delivery request screen 350, may permit the business 32 to input a number of requested orders 250, a response time 260, and a maximum discount 270.

In a more complex embodiment, shown in FIGS. 3a-3b, a business 32 may provide even greater capacity information 635 to the matching server 20, once again in the form of a request for orders 247. FIG. 3a illustrates a capacity entry screen 300 of the business application 34. The capacity entry screen 300 may include an ability to specify they order type 302 desired, such as, pick-up, delivery, both, etc. In other embodiments, order type 302 may also include dine-in. Additionally, the capacity entry screen 300 may include an input to enter a time slot 304 during which the orders 19 are desired. For a time slot 304, the employee 36 may enter an order quantity 306 and a time slot length 308 around the time slot 304 that the orders 19 are desired. The order quantity 306 in the example is expressed in terms of a number of food items the business 32 desires to sell. The order quantity 306 is analogous to the number of requested orders 250 and either one or both may be used in an embodiment to describe available capacity. The capacity entry screen 300 may permit the employee 36 to specify multiple capacity slots 310 with varying time slots 304, order quantities 306, order types 302, etc., to enable coverage of various periods of excess capacity. In the example shown, an employee 36 has indicated the capacity to make up to 8 pizzas in the 2:30, 3:30 and 4:30 capacity slots 310. During normal operation, the employee 36 may enter the available capacity into the business application 34 as needed, and modify or cancel the capacity information 635 as needed. In some embodiments, an employee 36 of the business 32 may input a schedule to automatically turn the business 32 ‘on’ for certain day at a certain time with present capacity amounts.

Turning to FIG. 3b, the business 32 may also input various permissible incentives 240 that may be included in an offer 17 to encourage the consumer 42 to accept the offer 17. As shown in the incentives input screen 320 of FIG. 3b, incentives 240 may include free delivery, a discount or percentage off the total, or free products and services. It is contemplated that incentives 240 may include any material or non-material reward that would be expected to induce a consumer 42 to accept an offer 17.

The matching server 20 may use the incentives 240 to continuously generate offers 17 until a sufficient number of orders 19 have been received to fill the available capacity of a business 32. For example, one-by-one, the matching server 20 may send out offers 17 to all consumers 42 that have indicated an interest in the business 32. If the response to offers 17 is low, the matching server 20 may periodically increase the value of the incentives 240 included in the offers 17 to improve the conversion rate. It is appreciated that there are many possible strategies for generating offers 17 and targeting offers 17 to various consumers 42, and, accordingly, the strategies disclosed herein will not be understood by those of skill in the art as limiting the system to any particular choice of offer generation and matching strategies.

Next, the business 32 may input existing deliveries into the other deliveries screen 330 of FIG. 3c. This permits the matching server 20 to take existing deliveries into account when weighing which consumers 42 should receive offers 17. As shown in the other deliveries screen 330, an employee 36 of the business 32 may be prompted with an input to enter a number of existing deliveries 332. According to the number of existing deliveries 332 entered, the other deliveries screen 330 may be updated to include a sufficient number of inputs to receive the delivery addresses 334 of all existing deliveries.

Finally, having inputted the relevant capacity information 635, the business 32 may review the capacity information 635 in a confirmation screen 340 as shown in FIG. 3d. The confirmation screen 340 may remind the employee 36 of the number of orders 19 requested for each order type 302 (pick-up, delivery, etc.), the response time 260 desired (or in some embodiments, the capacity for various time slots 304 and the time slot length 308), the number of requested orders 250 (or in some embodiments, the order quantity 306), and the maximum discount 270.

The capacity and demand matching system 15 is configured to independently generate offers 17 and provide them to consumers 42 without needing input from the business 32. Nevertheless, it is contemplated that some businesses 32 may desire to retain a level of control over the offers 17 made on their behalf. Accordingly, in some embodiments, before an offer 17 is made to a consumer 42, the business 32 may review the offer 17 and accept or reject it. When a potential offer 360 is generated, it may be sent to the business 32 for review. As shown, the potential offer 360 may be displayed in a popup menu along with details of the offer including the incentive 240. The employee 36 may choose a view button 364 to view details of the offer 17 and the consumer 42 it is being offered to, such as the consumer's current location 425, the consumer's quantity of goods and services desired 470, the consumer's order type 410 (pick-up, delivery, dine-in), etc. If the offer 17 is acceptable, the employee 36 may click the accept button 366 to have the offer 17 made to the consumer 42.

As previously described with respect to FIG. 2a, a consumer 42 may begin to receive offers 17 by simply turning herself ‘on’ for offers 17. It is contemplated that a consumer 42 need not even turn herself ‘on’ in order to receive offers 17. For example, offers 17 may be displayed automatically upon opening of the consumer application 44. This way, the act of affirmatively turning oneself ‘on’ may provide an additional signal that the consumer 42 is interested in receiving offers 17, while the mere act of opening the consumer application 44 may cause the consumer application to begin displaying offers 17.

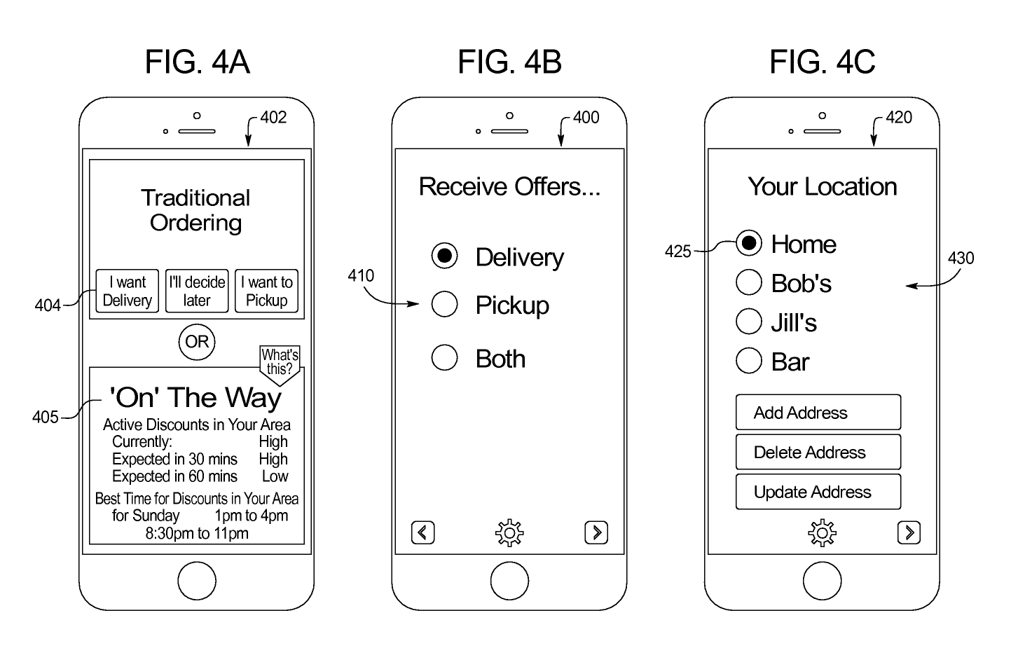

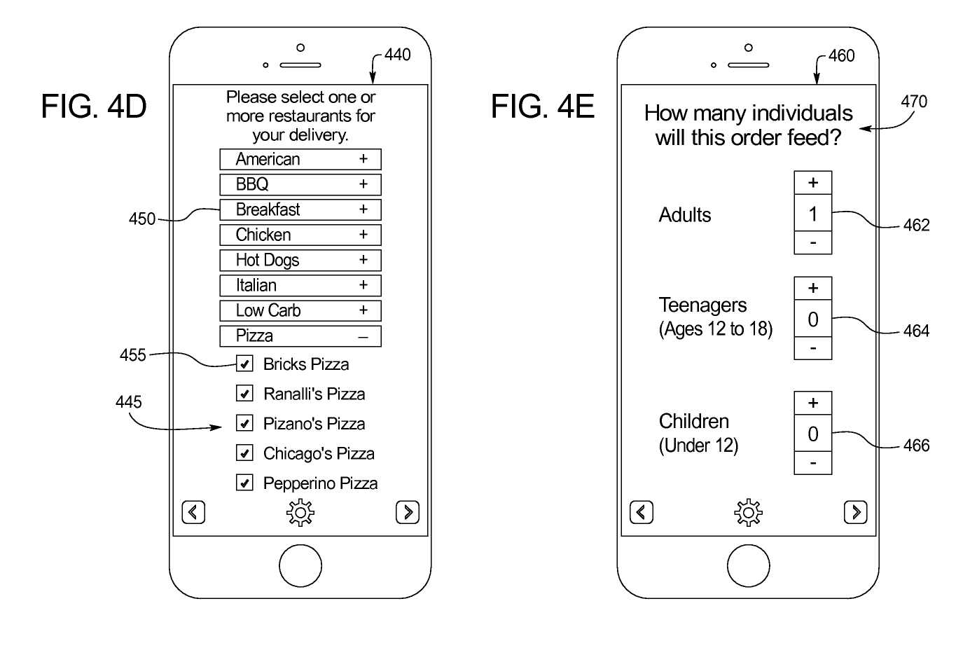

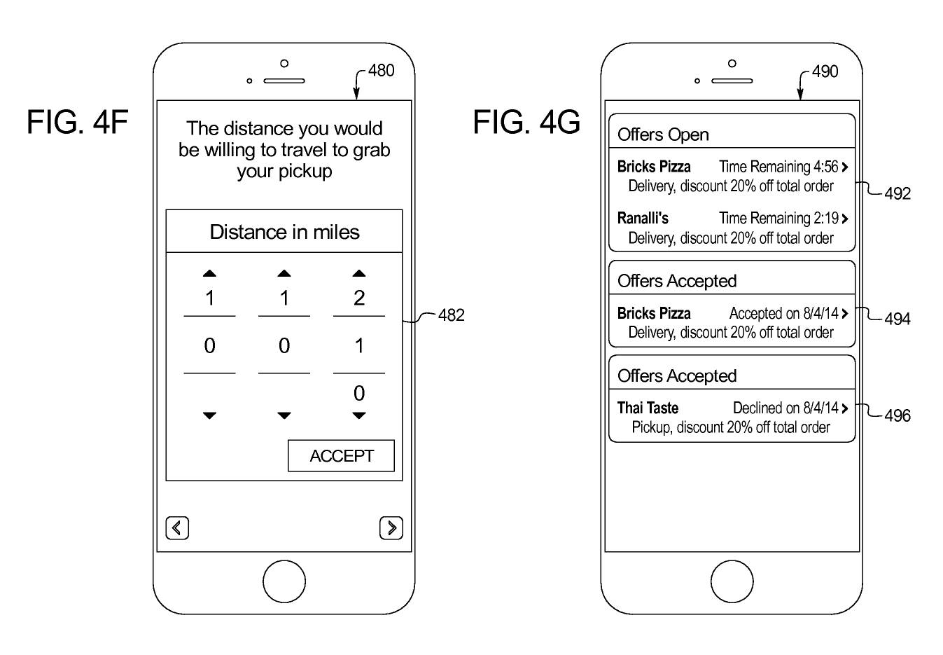

To permit the capacity and demand thatching system 15 to better tailor offers 17 to consumers 42, the consumer application 44 may include functionality to better determine consumer demand by developing a consumer profile 620 of the consumer 42. For example, as shown in FIGS. 4a-4f, the consumer application 44 may include menus to receive inputs of further information about the consumer's current preferences and interests regarding offers 17.

As shown in FIGS. 4a-4e, the consumer 42 may indicate various details of offers 17 the consumer 42 may be interested in. First, as shown in FIG. 4a, in the order method screen 402, the consumer 42 may choose to use traditional delivery options 404 to immediate order food, or may choose the ‘on’ option button 405 to turn herself ‘on’ for offers 17. The order method screen 402 may include available discounts information 406 that may be available to the consumer 42.

If the consumer 42 chooses to turn herself ‘on’, the consumer 42 may be taken to an order type screen 400 as shown in FIG. 4b. In the order type screen 400, the consumer 42 may select from the order types 410 to indicate interest in offers 19 for pick-up, delivery, or both. In other embodiments, dine-in may be a further option.

Then, as shown in FIG. 4c, the consumer 42 may proceed to a location screen 420 that prompts the consumer 42 to indicate her current location 425. The consumer's current location 425 may be used to determine nearby businesses 32 that the consumer 42 may be interested in receiving pickup from, or to determine where she will receive deliveries. As shown, the consumer 42 may be presented with a locations input 430. As shown, the locations input 430 may be radio selection buttons to permit the consumer 42 to select from a list of pre-populated locations. Additionally, in some embodiments, the consumer 42 may be permitted to use GPS to determine her current location 425. In further embodiments, the consumer 45 may be permitted to type in an address as the current location 425.

Next, as shown in FIG. 4d, the consumer 42 may be permitted to input a selection of businesses 445 into a restaurants screen 440 that indicate the restaurants or the categories of restaurants from which the consumer 42 would be interested in receiving offers 17 from. In the example shown, multiple category menus 450 are displayed as expandable accordion menus each containing selectable businesses 455. In some embodiments, the consumer 42 may select the category menus 450 to automatically select all the businesses 32 contained within. In some embodiments, a consumer 42 may input a schedule to automatically turn herself ‘on’ for a certain day at a certain time with preset choices for the selection of businesses 445.

Further, as shown in FIG. 4e, the consumer 42 may input of a quantity of goods and services desired 470 in the quantity screen 460. In the embodiment shown, the quantities of food are inputted as a number of people that an order is intended to feed. The consumer 42 may input a number of adults 462, a number of teenagers 464, and a number of children 466. In some embodiments, the number of adults 462, number of teenagers 464, and number of children 466 may be used to calculate an “adjusted number of adults.” For example, since teenagers only consumer eighty-eight percent of what an adult consumes, and a child consumers approximately fifty-six percent of what an adult consumes, any indicated teenagers and children may be counted as fractional adults, e.g., two adults plus two kids equals three and twelve-one-hundredths adults. It is contemplated that in other embodiments, the quantity of goods and services desired 470 may be inputted in other manners, such as, a selection of particular goods and services, a price range of goods and services, or a selection of incentives 240 desired. Additionally, in some embodiments, the quantity of goods and services desired 470 may be used to estimate the amount of revenue that would be received from the resulting order and matching server may preferentially send offers to those consumers 42 having a higher estimated amount of revenue based on the quantity of goods and services desired 470 indicated.

Next, turning to FIG. 4f, when the consumer 42 has indicated an interest in pickup orders 19, the consumer 42 may be prompted to indicate the distance she would be willing to travel to make the pickup. For example, in a travel distance screen 480, the consumer 42 may be prompted to enter a travel distance 482. The matching server 20 may then restrict the offers 17 it provides to the consumer 42 to those businesses 32 that are within the travel distance 482 provided by the consumer 42.

In some embodiments, as shown in FIG. 4g, an overview screen 490 may be displayed to permit the consumer 42 to review open offers 492, accepted offers 494, and declined offers 496. For open offers 492, the remaining time of the time limit 246 may be displayed to permit the consumer 42 to review the available offers 17.

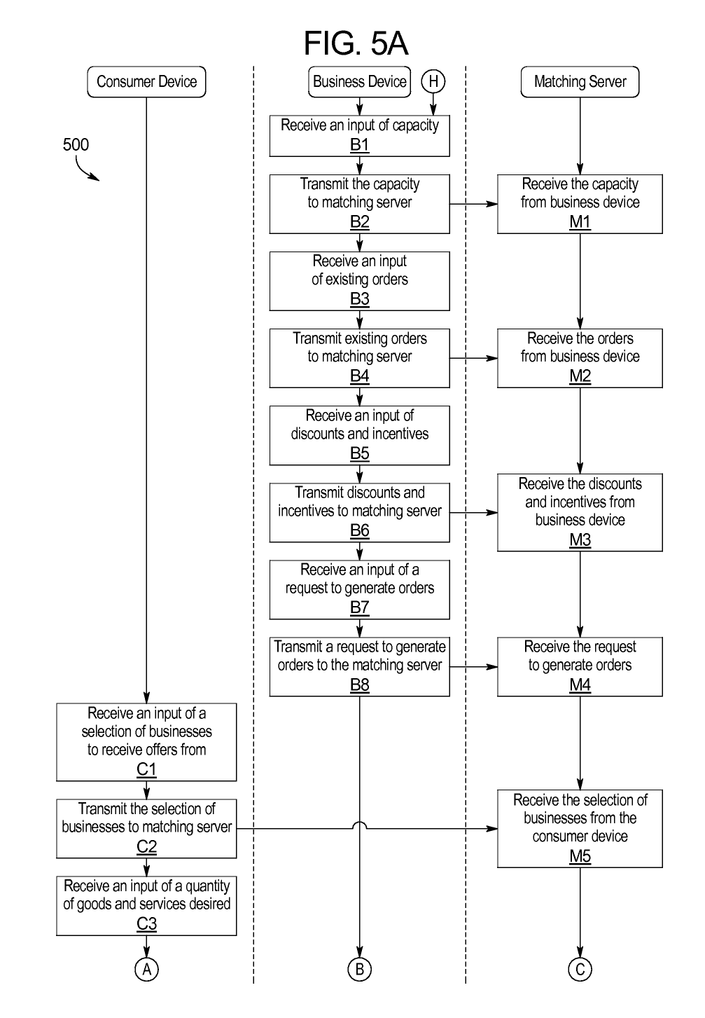

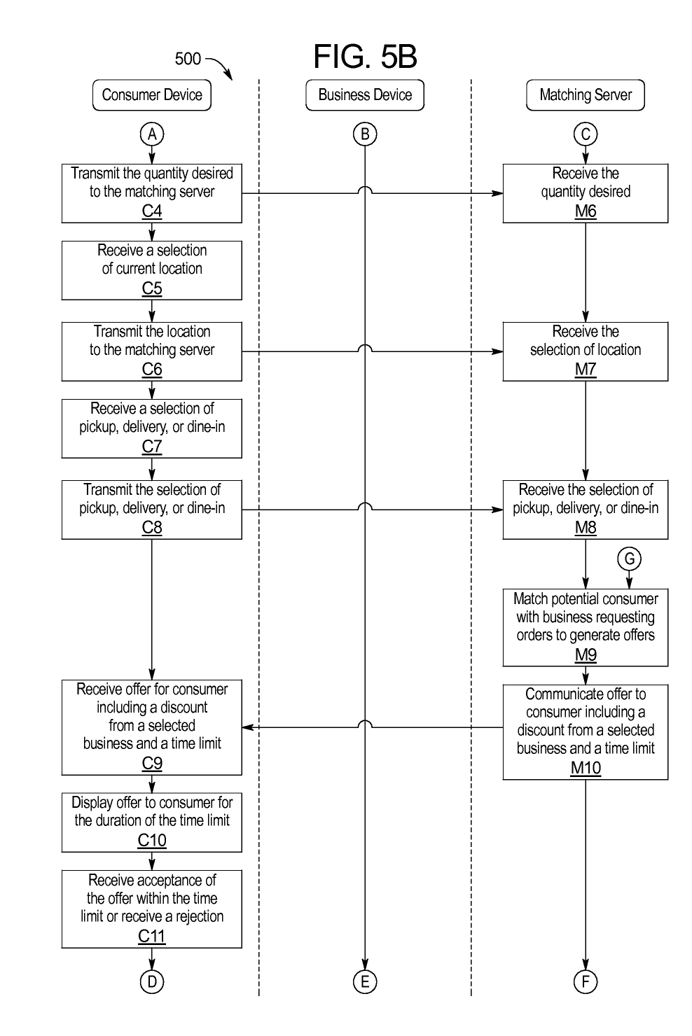

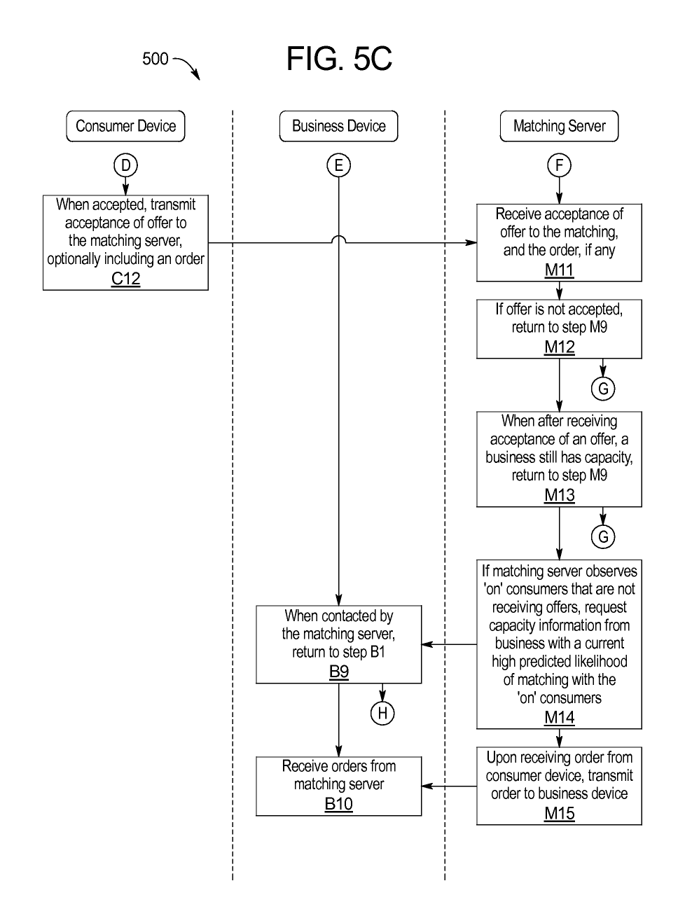

Turning to FIGS. 5A to 5c, a capacity and demand matching method 500 is provided to provide the functionality of the capacity and demand matching system 15. In the embodiment shown, steps of the capacity and demand matching method 500 are described as being performed by one of the consumer device 40, the business device 30 and the matching server 20. It is contemplated that in other embodiments, that steps listed as being performed by the consumer 40 device or the business device 30 may be performed by the matching server 20, and steps being listed as being performed by the matching server 20 may be performed by the business device 30 or the consumer device 20. Additionally, it is contemplated that in other embodiments, some steps may be omitted, performed in an alternate order, and that further steps may be included.

The capacity and demand matching method 500 may begin when the employee 36 of a business 32 enters capacity information 635 into the business device 30. For example, at step B1, the business device 30 receives an input of capacity (such as a number of requested orders 250, a response time 260, and a maximum discount 270, or a order type 302, a time slot 304, an order quantity 306, and a time slot length 308); and at step B2, the business device 30 transmits the capacity to matching server 20 that receives the capacity at step M1. Next, at step B3, the business device 30 receives an input of existing orders 19, and at step B4, transmits the existing orders 19 (including the existing delivery addresses 334) to matching server 20 that receives the existing orders 19 at step M2. Then, at step B5, the business device 30 receives an input of discounts and incentives 240, and, at step B6, transmits the discounts and incentives 240 to matching server 20 that receives the discounts and incentives 240 at step M3. Finally, at any time and regardless of capacity information 365 provided, at step B7, the business device 30 may receive an input of a request for orders 247, and at step B8, transmit the request for orders 247 to the matching server 20 that receives it at step M4. Upon receiving the capacity information 635, it may be stored in the business profile 630. And, upon receiving a request for orders 247, the on status 621 of the business 32 may be updated.

Also, as reflected in the capacity and demand matching method 500, the consumer 42 may also enter demand information 625 into the consumer device 40. First, at step C1, the consumer device 40 receives an input of a selection of businesses 445 to receive offers 17 from, and at step C2, the consumer device 40 transmits the selection of businesses 445 to the matching server where it is received at step M5. Next, at step C3, the consumer device 30 receives an input of a quantity of goods and services desired 470, and at step C4, the consumer device 30 transmits the quantity of goods and services desired 470 to the matching server 20 where they are received at step M6. Then, at step C5, the consumer device 40 receives a selection of a current location 425, and at step C6, the consumer device 40 transmits the current location 425 to the matching server 20 that receives the current location 425 at step M7. Further, at step C7, the consumer device 30 receives a selection of pickup, delivery, or dine-in (the order type 410), and at step C8, the consumer device transmits the order type 410 to the matching server 20 that receives it at step M8. Upon receiving the demand information 625, the matching server 20 may store it in the consumer profile 620.

The matching server 20 may continuously make offers 17 to consumers 42 in order to generate orders 19 for businesses 32. As reflected in the capacity and demand matching method 500, the matching server, at step M9, matches a consumer 42 with a business 32 to generate an offer 17, and at step M10, the matching server 20 communicates the offer 17 to the matched consumer 42. The offer 17 may include a incentive 240 from the selected (matched) business 32 and a time limit 246.

Upon receiving an offer 17 at step C9, the consumer device 40 displays the offer 17 to the consumer 42 for the duration of the time limit 246 at step C10. The consumer 42 may view the offer 17 and accept or decline it. At step C11, the consumer device 40 receives acceptance of the offer 17 within the time limit 246 or receives a rejection. When the offer 17 is accepted within the time limit 246, at step C12, the consumer device 30 transmits the acceptance of the offer 17 to the matching server 20 that receives acceptance at step M11. The acceptance of the offer 17 may be, or may include, an order 19. At step M12, if the offer 17 is not accepted, the matching server 20 returns to step M9 to generate further offers 17. And, when, after receiving acceptance of an offer 17, the business 32 still has available capacity, the matching server 20 may return to step M9 to generate further offers 17. For any orders 19 received from the consumer device 40, at step M15, the matching server 20 transmits the order to the business device 30, and the order 19 is, in turn, received by the business device 30 at step B10.

In addition to continuously generating offers 17, the matching server 20 may continuously check for imbalances between the capacity available by businesses 32 and the demand from consumers 42. Accordingly, at step M14 of the capacity and demand matching method 500, if the matching server 20 observes ‘on’ consumers (as may be reflected in the on status 621 and demand information 625) that are not receiving offers 17, the matching server 20 may request capacity information 635 from businesses 32 with a current high predicted likelihood of matching with the ‘on’ consumers.' The predicted likelihood of matching with ‘on’ consumers 42 may be calculated from the consumer profiles 620, including the consumers' selection of businesses 44, consumers' feedback history 623, transaction history 622, etc. Then, when contacted by the matching server 20, the business device 30 may return to step B1 to receive input of capacity information 635.

FIG. 6a is a block diagram illustrating the components of an example matching server 20 of the capacity and demand matching system 15. As shown, the matching server 20 may include a controller 602 for executing matching server instructions 605 stored in a memory 604. A network interface 606 in communication with the controller 602 permits the controller 602 to communicate with the consumer device 40 and the business device 30 over a network, such as the Internet. The matching server 20 may include a database 610 that is in communication with the controller 602 and that stores consumer profiles 620 and business profiles 630 for use in carrying out the functionality of the capacity and demand matching system 15.

The matching server 20 may use consumer metrics 640 and business metrics 650 to match consumers 42 and businesses 32 when generating offers 17. The consumer metrics 640 and business metrics 650 may be derived from the information stored in the consumer profiles 620 and the business profiles 630. The matching server 20 may be in communication with a consumer device 40 and a business device 30. Example block diagrams of the consumer device 40 and the business device 30 are shown in FIGS. 6b and 6c, respectively. The consumer device 40 and the business device 30 may both include a controller; a memory 604, a network interface 606, and a user interface 608. The memory 604 of the consumer device 40 may store the consumer application 44; likewise, the memory of the business device 30 may store the business application 34.

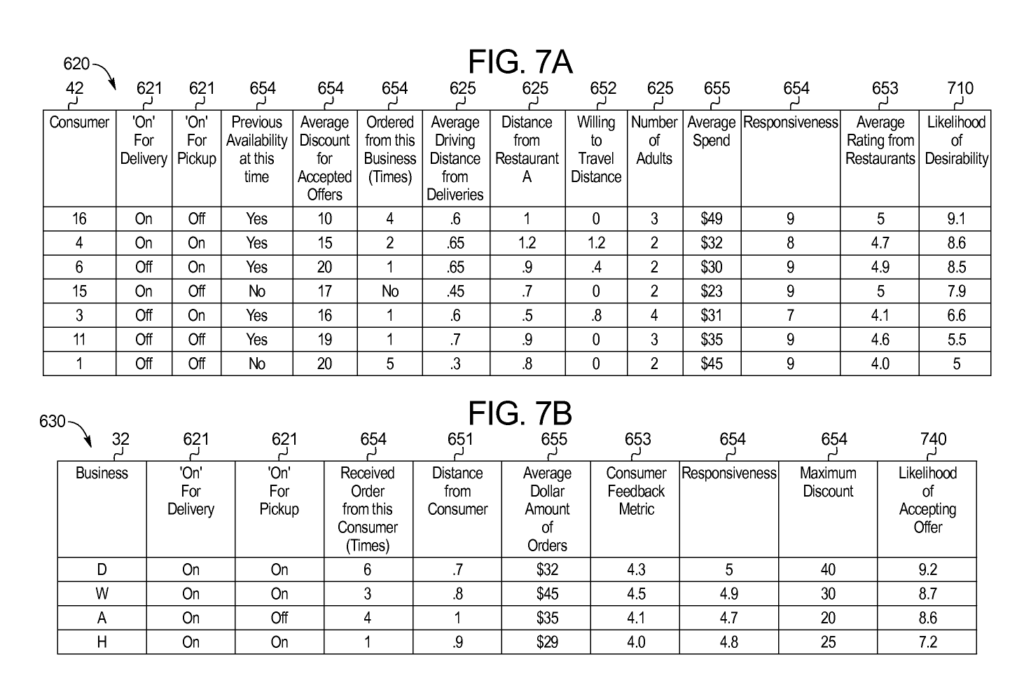

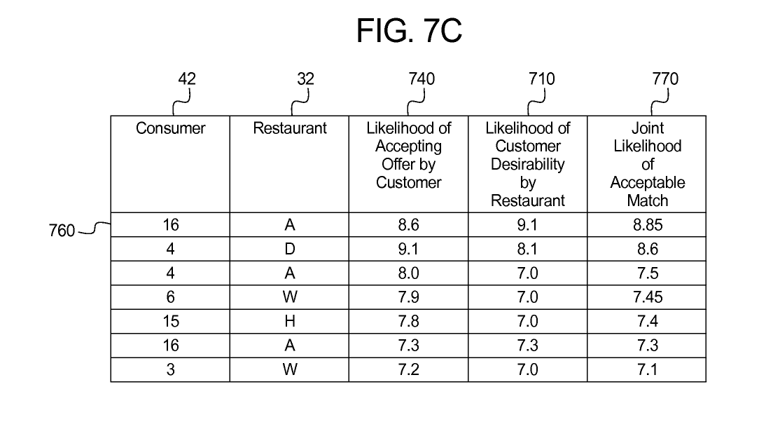

As shown in FIG. 7a, for each consumer 42 that has selected a business 32, the matching server 20 may calculate a likelihood of desirability 710 of that consumer 42 to the business 32. The likelihood of desirability 710 may be calculated based on the consumer metrics 640 and any other information in the consumer profile 620 or the business profile 630. In the example shown, a portion of the consumer profiles 620 for consumers 42 that have selected a “Restaurant A” are shown, to illustrate some of the data values that may be used in calculating the likelihood of desirability 710. In an embodiment, the matching server 20 may select consumers 42 with a high likelihood of desirability 710 and send those consumers 42 offers 17 from the business 32.

Likewise, as shown in FIG. 7b, for each business 32 that has been selected by a consumer 42, the matching server 20 may calculate a likelihood of acceptance 740 of an offer 17 from the business 32 by the consumer 42. The likelihood of acceptance 740 may be calculated based on the business metrics 650, and any other information in the business profile 630 or the consumer profiles 620. In the example shown, a portion of the business profiles 630 for businesses 32 selected by a “Consumer 16” are shown to illustrate some of the data values that may be used in calculating the likelihood of acceptance 740. In an embodiment, the matching server 20 may select businesses 42 with a high likelihood of acceptance 740 for a consumer 42 and send the consumer 42 offers 17 from those businesses 32.

As noted, the consumer metrics 640 and business metrics 650 may be derived from the information stored in the consumer profiles 620 and the business profiles 630. Availability metrics 651 indicate the availability of the business 32 to receive additional orders 19. For example, a business 32 may indicate that it is currently ‘off’ for pickup and delivery orders 19. A business 32 may turn itself ‘off’ during times of the day or week that it is traditionally busy with other orders 19, for example, for many restaurants the Friday night period from 6:30 pm until 8:30 pm is usually too busy to need additional demand. Alternatively, a business 32 may be ‘off’ because they are closed. When the business is ‘off,’ consumers 42 may still be permitted to make traditional orders 19 using the consumer application 40, however, the system may refrain from making offers 17 on behalf of the business 32. In some embodiments, a business 32 may schedule periods of availability or non-availability to receive orders 19. Alternatively, a business 32 that has scheduled itself to be ‘off’ may find they are slower than usual (e.g., has underused capacity) and may turn themselves ‘on’ and available for orders 19, as needed throughout the business day.

In the consumer context, availability metrics 651 indicate the availability of the consumer 42 to make an order 19. For example, availability metrics 651 may include whether the consumer 42 is currently turned ‘on’ to indicate a willingness to receive offers 17. Additionally, availability metrics 651 may include the consumer's distance from the business 32.

Desirability metrics 652 indicate the general desirability of a particular business 32 to consumers 42, and vice versa. The desirability of a business 32 may be derived from the interests expressed by consumers 42 when they turn themselves ‘on.’ For example, consumers 42 may indicate an interest in receiving offers 17 from particular businesses 42 as shown in FIG. 4d. Desirability metrics 652 may also include the number of consumers 42 nearby the business and may take into account the distance each consumers 42 has indicated he or she would be willing to travel. A further example of a desirability metrics 652 is the number of consumers 42 who have indicated an interest in a category a business is classified in.

Transaction history metrics 654 may consider the past history of businesses 42 and consumer 42 with the capacity and demand matching system 15, such as previous orders a business 32 or consumer 42 has completed. For example, transaction history metrics 654 may take into account, for example, the times of day, the days of week, the days of the month, etc., that businesses 42 have had available capacity. Additionally, the transaction history metrics 654 may take into account the responsiveness of business 32 after being contacted by the matching server 20 to obtain capacity information 635.

In the consumer profile 620, transaction history metrics 654 may consider the past history of consumers 42 with the capacity and demand matching system 15. For example, transaction history metrics 654 may take into account the previous orders 19 a consumer 42 has completed. Transaction history metrics 654 may take into account, for example, the times of day, the days of week, the days of the month, etc., that consumers 42 have completed orders 19. Additionally, the transaction history metrics 654 may take into account the responsiveness of a consumer 42 after being contacted with an offer 17.

Transaction value metrics 655 may consider the value of past transactions completed by businesses 32 via the capacity and demand matching system 15. In the business profile 630, transaction value metrics 655 may include the average spend per order 19 purchased from a business 32 by a consumer 42 over previous periods. Transactions value metrics 655 may further include the average dollar amounts of orders 19 for a business 32. Further, the transaction value metrics 655 may take into account the total of all transaction values over particular periods comparable to the period for which offers 17 are desired. For example, if offers are desired for 2 p.m.-4 p.m. on a weekday, the system may look at previous weekdays at the same time to gauge likely transaction values.

In the consumer context, transaction value metrics 655 may consider the value of past transactions completed by the consumer 42 via the capacity and demand matching system 15. Transaction value metrics 655 may include the average dollar amounts of orders purchased by a consumer 42 over previous periods. Alternatively, transaction value metrics 655 may be weighted in comparison to other consumers 42. Additionally, the transaction value metrics may take into account the transaction values over particular periods comparable to the period for which extra capacity is desired by businesses 42. Transaction value metrics 655 may also take into account whether the consumer 42 spends more or less on average during a particular time of the day compared to other times of the day, on a particular day compared to other days, on a particular time of day compared to other times of the day, and in comparison to other consumers 42. Further, transaction value metrics 655 may take into account whether a particular consumer 42 has made large and/or small outlier pick-up order transaction values that may be removed to get a better average purchase value. Transaction value metrics 655 may additionally take into account the previous order amounts per person per order, and preferentially make offers to consumers 42 with high order amounts per person per order to encourage consumers 42 to refrain from making small orders 19.

Feedback metrics 653 include metrics that are derived from feedback history 623 of businesses 32 and consumers 42. Consumers 42 may be permitted to provide ratings, reviews, rankings, comments, complaints, and other feedback about orders placed through the system. Accordingly, Feedback metrics 653 may include metrics that are derived from consumer feedback about a business 32. For example, the ratings of a business 32 may be aggregated into a consumer feedback metric 653 for the business 32. Feedback metrics 653 may additionally include information about any steps a business 32 took to respond to negative reviews, complaints, including whether a refund or credit was given.

Feedback metrics 653 may include the complaint history of consumers 42. For example, consumers 42 with a history of excessive complaints or refund requests may be weighted lower. If a consumer 42 has given complaints, the feedback metrics 653 for a business 32 may include the ratio of orders 19 with complaints to orders 19 without complaints, and/or the ratio of orders with complaints to total orders made by the consumer 42. These ratios can be expressed in total number of orders 19 and/or in dollar amounts. Additionally, the feedback metrics 653 may be adjusted based on the evolution of the ratios over various periods of times, and may be adjusted based on a comparison with other consumer 42. Similarly, feedback metrics 653 may be adjusted based on whether a consumer 42 requested and/or received refunds or credits to settle disputes. Further, in some embodiments, businesses 42 may be permitted to rate consumers 42. The business ratings may be aggregated into an average rating from restaurants feedback metric 653.

As noted, consumers 42 and businesses 32 may be matched using a calculated likelihood of desirability 710 of consumer 42 for a business 32, and a calculated likelihood of acceptance 740 when a consumer 42 receives an offer 17 from a business 32. FIG. 7c is a table illustrating ranked matches of pairs of businesses 32 and consumers 42. As shown, the matching server 20 may generate one or more candidate matches 760 of consumers 42 and businesses 32. For example, the matching server 20 may generate candidate matches from those consumers 42 with a high likelihood of desirability 710 for one or more businesses 32, and/or may generate matches from those businesses 32 with a high likelihood of acceptance 740 of an offer 17 by one or more consumers 17. Alternatively, the matching server 20 may generate a candidate match for all pairs of consumers 42 and businesses 32 that are have on status 621 that is ‘on’ for one of pickup, delivery, dine-in, etc. For each candidate match 760, the matching server 20 may combine the likelihood acceptance 740 with the likelihood of desirability 710 to generate a joint likelihood of an acceptable match 770. The matching server 770 may then make offers 17 to each consumer 42 of one or more candidate matches 760 having the highest joint likelihood of an acceptable match 770.

As noted, in some embodiments, the business 42 may provide a number of delivery drivers 352 to permit the system to make offers 17 that optimize the use of the delivery drivers. In an embodiment, for a business 42, the matching server 20 may divide customers 42 that have selected the business 42 (the selected customers 42) into a number of clusters (for example, by using k-means clustering) with a fixed number of clusters equal to the number of available delivery drivers. Any existing delivery addresses 334 may be assigned to the nearest cluster. After assigning each selected customers 42 to a cluster, the matching server 20 may calculate the distance of each selected customer 42 from the center of his or her assigned cluster. The calculated distance may be used to weight, or included in the calculation of, the likelihood of desirability 710 such that selected customers 42 that are close to the center of the cluster are matched preferentially over the selected customers 42 at the periphery of the cluster.

In another embodiments, the existing delivery addresses 334 may be used to nucleate clusters. For example, the existing delivery addresses 334 may each be assigned to one of the empty clusters (nearby existing delivery addresses 334 may be assigned to the same cluster). Then, the selected customers 42 may be assigned to the nearest cluster. Once again, after assigning each selected customers 42 to a cluster, the matching server 20 may calculate the distance of each selected customer 42 from the center of his or her assigned cluster. Finally, the calculated distance may be used to weight, or included in the calculation of, the likelihood of desirability 710 such that selected customers 42 that are close to the center of the cluster are matched preferentially over the selected customers 42 at the periphery of the cluster.

An offer 17 will identify the business 32 that the consumer 42 has been matched with. To encourage the consumer 42 to accept the offer 17 and place an order 19, an offer 17 may include the maximum discount 270 provided by the business 32 as an incentive 240. Alternatively, the incentive 240 may be a discount less than the maximum discount 270, for example, the incentive 240 may be equal to the average discount of all offers 17 accepted by the consumer 42. Additionally, the offer 17 may include time limit 246 equal to the response time 260 indicated by the business 32, or equal to the time slot length 308.

As noted, the capacity and demand matching system 15 may monitor the demand information 625 and capacity information 635 of the consumer profiles 620 and business profiles 630. When there is an excess of demand, the matching server 20 may contact businesses 30 and encourage them to turn themselves ‘on.’ The matching server 20 may reach out to the specific businesses 32 that have the highest likelihood to provide an offer 17 that will be accepted by consumers 42 when queried. The likelihood to provide an offer may be calculated based on the consumer metrics 640 and business metrics 650. Examples of consumer metric 540 640 and business metrics 650 that may indicate a high probability of providing an offer 17 that will have a high likelihood of acceptance by the consumer 42 when queried includes the availability metrics 651, feedback metrics 653, transaction history metrics 654, transaction value metrics 655 etc. One skilled in the art will appreciate that these metrics are example metrics and that other metrics may be used, and the listed metrics may be omitted or adapted in various ways.

It is contemplated that the capacity and demand matching system 15 may not always have sufficient information about the consumer 42 or the business 32 to generate offers 17 for each consumer 42 or business 32. For example, a consumer 42 and a business 32 “new” to the system may simply turn themselves “on” without indicating any present capacity or demand. In these circumstances, in some embodiments, the capacity and demand matching system 15 may generate offers 17 based on other businesses 32 and consumers 42 in the system, such as “most popular” offers 17, offers 17 based on business or consumer demographic preferences, random offers, etc. By generating offers 17 for consumers 42 with undeveloped consumer profiles 620, the capacity and demand matching system 15 ensures that new or infrequent consumer 42 and a business 32 will still receive offers 17 and orders 19.

Additionally, it is contemplated there may occur times when a consumer 42 turns herself ‘on’ where she doesn't receive sufficient offers 17 to keep her interested in the system. This may occur for a variety of reasons, such as, low capacity in the system resulting in small discounts. If this were to occur frequently, it may cause the capacity and demand matching system 15 to lose consumer users. Accordingly, the system may monitor for signs that a consumer 45 is losing interest. For example, the system may determine that the amount of time a consumer 45 is ‘on’ is decreasing over time (such as forty minutes the first five times, and then twenty minutes the next three times). Alternatively, the system may determine that the time between ‘on’ sessions is increasing. To prevent this situation from causing consumers 42 to leave the system, the system may ‘override’ the normal matching patterns to generate offer 17 geared to retain the consumer 42. In some embodiments, the owners of the capacity and demand matching system 15 rather than the business 32 providing the offer 17 may pay for the incentives 240 provided in an offer 17 created by an override.

In an embodiment, an override may be triggered when the number of times an offer was sent divided by the number of times the ‘on’ consumer goes below a threshold. In another embodiment, an override may be triggered when the number of times an offer 17 was accepted divided by the number of times ‘on’ consumer 42 goes below a threshold. In an additional embodiment, an override may be triggered when the number of times offer was selected by a consumer 42 divided by the number of times an offer was sent to the consumer 42 goes below a threshold. From the example provided, many other alternative formulas for determining when to override the existing matching will be apparent to those of ordinary skill in the art.

As used in herein, the word likelihood is used to denote the output of one or more predictive analytics calculations that determine a probability, or likelihood, using one or more metrics as inputs. Predictive analytics calculations may be embodied in a variety of statistical techniques from modeling, machine learning, and data mining that analyze the one or more metrics and output predictions. For example, predictive analytics calculations may be made using linear regression models, logistic regression models, multivariate regression, neural networks, support-vector machines, naïve Bayes classifiers, etc. Those of ordinary skill in the art will understand that a variety of techniques may be used to make predictive analytics calculations and that the present disclosure is not meant to be limiting in any way.

Aspects of the systems and methods described herein are controlled by one or more controllers 20. The one or more controllers 602 may be adapted run a variety of application programs, access and store data, including accessing and storing data in associated databases, and enable one or more interactions via the capacity and demand matching system 15. Typically, the one or more controllers 602 are implemented by one or more programmable data processing devices. The hardware elements, operating systems, and programming languages of such devices are conventional in nature, and it is presumed that those skilled in the art are adequately familiar therewith.

For example, the one or more controllers 602 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories include a main memory 604, such as a dynamic random access memory (DRAM) and cache, as well as a read only memory, such as a PROM, EPROM, FLASH-EPROM, or the like. The system may also include any form of volatile or non-volatile memory 604. In operation, the main memory 604 stores at least portions of instructions for execution by the CPU and data for processing in accord with the executed instructions.

The one or more controllers 602 may also include one or more input/output interfaces for communications with one or more processing systems. One or more such interfaces may include a network interface 606 to enable communications via a network, e.g., to enable sending and receiving instructions electronically. The communication links may be wired or wireless.

The one or more controllers 602 may further include appropriate input/output ports for interconnection with one or more output displays (e.g., monitors, printers, touchscreen, motion-sensing input device, etc.) and one or more input mechanisms (e.g., keyboard, mouse, voice, touch, bioelectric devices, magnetic reader, RFID reader, barcode reader, touchscreen, motion-sensing input device, etc.) serving as one or more user interfaces for the processor. For example, the one or more controllers 602 may include a graphics subsystem to drive the output display. The links of the peripherals to the system may be wired connections or use wireless communications.

Although summarized above as a PC-type implementation, those skilled in the art will recognize that the one or more controllers 602 also encompasses systems such as host computers, servers, workstations, network terminals, and the like. Further one or more controllers 602 may be embodied in a device, such as a mobile electronic device, like a smartphone or tablet computer. In fact, the use of the term processor is intended to represent a broad category of components that are well known in the art.

Hence aspects of the systems and methods provided herein encompass hardware and software for controlling the relevant functions. Software may take the form of code or executable instructions for causing a controller 602 or other programmable equipment to perform the relevant steps, where the code or instructions are carried by or otherwise embodied in a medium readable by the processor or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a controller 602 for execution.

It should be noted that various changes and modifications to the presently preferred embodiments described herein will be apparent to those skilled in the art. Such changes and modifications may be made without departing from the spirit and scope of the present invention and without diminishing its attendant advantages.

1. A capacity and demand matching system comprising:
a controller;
a computer-readable non-transitory memory including instructions, that when executed by the controller, cause the controller to:
receive, from a user interface, indications of user demand;
communicate the indications of user demand to the server;
receive, from the server, an offer for sale; and
display, via the user interface, the offer for sale;
wherein
the indications of user demand include an address, a selection of businesses, and a quantity demanded;
the offer for sale identifies a business providing the offer, a discount, and a time period for acceptance; and
the business providing the offer is selected from the selection of businesses.

2. The system of claim 1, wherein the selection of businesses is received as one or more categories of businesses.

3. The system of claim 1, wherein the selection of businesses is received as an identification of two or more businesses.

4. The system of claim 1, wherein the quantity demanded is received as an identification of a number of persons.

5. The system of claim 1, wherein the quantity demanded is received is indicated by a selection of food items.

6. The system of claim 1, wherein the indications of user demand further include a minimum discount.

7. The system of claim 1, where in the indication of user demand further include a price range.

8. A capacity and demand matching system, comprising:
a controller;
a computer-readable non-transitory memory including instructions, that when executed by the controller, cause the controller to:
receive, from a user via a user interface, indications of user capacity;
communicate the indications of user capacity to the server;
receive, from the server, an accepted sale; and
displaying, via the user interface, the accepted sale;
wherein
the indications of user capacity include a desired number of sales, an incentive, and a time period; and
the accepted sale identifies a consumer, an address, and an order of goods, services, or goods and services provided by the user.

9. A capacity and demand matching system comprising:
a controller;
a computer-readable non-transitory memory including instructions, that when executed by the controller, cause the controller to:
receive, from a consumer device of the consumer devices, indications of user demand;
receive, from a supplier device of the supplier devices, indications of supplier demand; and
communicate, to the consumer device, an offer for sale;
wherein
the indications of user demand include an address, a selection of businesses, and a quantity demanded;
the indications of user capacity include a desired number of sales, an incentive, and a time period.
